(19) United States
(12) Patent Application Publication
(10) Pub. No.: US 2024/0370970 A1
(43) Pub. Date: Nov. 7, 2024

(54) Encoding for Non-Linear Visual Data Sampling

(71) Applicant: Meta Platforms Technologies, LLC, Menlo Park, CA (US)

(72) Inventors: Sushant KONDGULI, Newark, CA (US); Abhinav GOLAS, Burlingame, CA (US); Carl MARSHALL, Portland, WA (US)

(21) Appl. No.: 18/310,259

(22) Filed: May 1, 2023

(51) Int. Cl. G06T 3/40; G06T 7/90; G06T 11/00

(52) U.S. Cl. CPC G06T 3/40; G06T 7/90; G06T 11/001; G06T 2207/10024; G06T 2207/20021

(57) ABSTRACT

Aspects of the present disclosure are directed to applying encoding techniques for non-linear visual data sampling. Visual data, such as an image or texture, can be sampled, for example to determine color values at different points of the visual data. Some visual data includes discontinuous content (e.g., a stark color boundary). Conventional sampling techniques (e.g., linear filtering) rely on averaging when calculating color values for sampled points of visual data. Such averaging can deteriorate the integrity of a stark color boundary, and thus this conventional sampling often performs poorly when used to sample visual data with discontinuous content. Implementations generate encodings for visual data comprising discontinuous content that can be effectively sampled. For example, an encoding manager can store the visual data according to an encoding scheme that can be sampled for improved color selection performance using one or more encoding specific sampling techniques.

### TECHNICAL FIELD

The present disclosure is directed to applying encoding techniques for non-linear visual data sampling.

### BACKGROUND

Computing systems can render content using visual data, such as an image or texture file, and display such content via display hardware. The sophistication of these rendering and display techniques has progressed over time, and recent trends in technology have increased this pace. For example, artificial reality systems leverage highly complex software to render content and immerse a user in a three-dimensional environment. Different scenarios can create different contexts in which to render content. For example, a user immersed in a three-dimensional environment can explore the three-dimensional environment. When the user is close in proximity to content in the environment, it may be rendered in a larger scale and/or with a higher degree of detail. On the other hand, when the user is further from the content, it may be rendered at a lower scale and/or with a lower degree of detail. Software techniques can improve a computing system's capability to render and display content in different contexts.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 illustrates conceptual diagrams of a portion of visual data and the portion of visual data after conventional sampling.

FIG. 6 illustrates a graph that compares ground truth visual data and sampled visual data.

FIGS. 7A and 7B illustrate conceptual diagrams of segmented visual data.

FIG. 8 illustrates a conceptual library of discontinuous visual data encodings.

FIG. 9 illustrates a conceptual diagram of an encoding for discontinuous visual data with variable segment sizes.

FIG. 10 is a flow diagram illustrating a process used in some implementations of the present technology for generating encodings for discontinuous visual data.

FIG. 11 is a flow diagram illustrating a process used in some implementations of the present technology for sampling discontinuous visual data encodings.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to applying encoding techniques for non-linear visual data sampling. Visual data, such as an image, texture, data stored as a bitmap, etc., can be sampled, for example to determine color values at different points of the visual data. Some visual data includes discontinuous content (e.g., a stark color boundary), such as text of a given color against a background of another color. Conventional sampling techniques (e.g., linear filtering) rely on averaging when calculating color values for sampled points of visual data. Such averaging can deteriorate the integrity of a stark color boundary, and thus this conventional sampling often performs poorly when used to sample visual data with discontinuous content. Implementations generate encodings for visual data comprising discontinuous content that can be effectively sampled. For example, an encoding manager can store the visual data according to an encoding scheme that can be sampled for improved color selection performance using one or more encoding specific sampling techniques.

The encoding manager can generate an encoding for visual data (e.g., an image, a texture, a bitmap representation of visual data, etc.) by initially segmenting the visual data into multiple segments (e.g., a grid). A given segment of the visual data can be generated such that the content of the segment has a single discontinuous portion (e.g., color boundary) with respect to two color values. In some implementations, the following encoding data can be stored for a given segment: two color values that represent two different colors; and one or more configuration values, such as four values that correspond to the four corners of the given segment. The configuration values (e.g., values that correspond to the four corners of the segment) can represent values used to distinguish the two colors at different locations within the segment.

The encoding of the visual data can be used to sample points of the visual data, for example for upscaling or downscaling (e.g., altering the rendered/displayed scale) the visual data. Sampling the encoding of the visual data can include performing an encoding specific sampling technique using coordinates for a plurality of points (e.g., coordinates with respect to the visual data bitmap). For example, for a given point with given coordinates, the encoding specific sampling technique can include: determining the segment for the given point and the point location within the segment; performing linear filtering using the one or more values (e.g., corner values) of the segment encoding and the point location within the segment; applying a non-linear function (e.g., Rectified Linear Unit (ReLu), sigmoid, etc.) to the output of the linear filtering; and resolving the result of the non-linear function application to select one of the two color values of the segment encoding. The encoding specific sampling technique can resolve color values for the visual data so that discontinuous portions of the visual data can be rendered/displayed at different scales with improved fidelity.

In some implementations, the sampled points can be used to display the versions of the visual data in an artificial reality environment. For example, artificial reality systems can perform sophisticated rendering (e.g., rendering passes) and the encoding specific sampling techniques can be incorporated with such sophisticated rendering to improve the display of content with stark color boundaries in artificial reality.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Conventional sampling techniques (e.g., linear filtering) rely on averaging when calculating color values for sampled points of visual data. Such averaging can deteriorate the integrity of a stark color boundary, and thus this conventional sampling often performs poorly when used to sample visual data with discontinuous content. Other compute intensive sampling techniques, such as signed distance fields and vector graphics techniques, consume significant system resources and present compute workloads that result in relatively slow performance.

Implementations generate encodings for visual data comprising discontinuous content that can be effectively and efficiently sampled. For example, an encoding manager can store the visual data according to an encoding scheme that can be sampled for improved color selection performance using one or more encoding specific sampling techniques. The encoding specific sampling technique can resolve color values for the visual data so that discontinuous portions of the visual data can be rendered/displayed at different scales with improved fidelity. In addition, the encoding specific sampling technique presents compute workloads that are relatively quick and efficient to execute when compared to compute intensive sampling techniques.

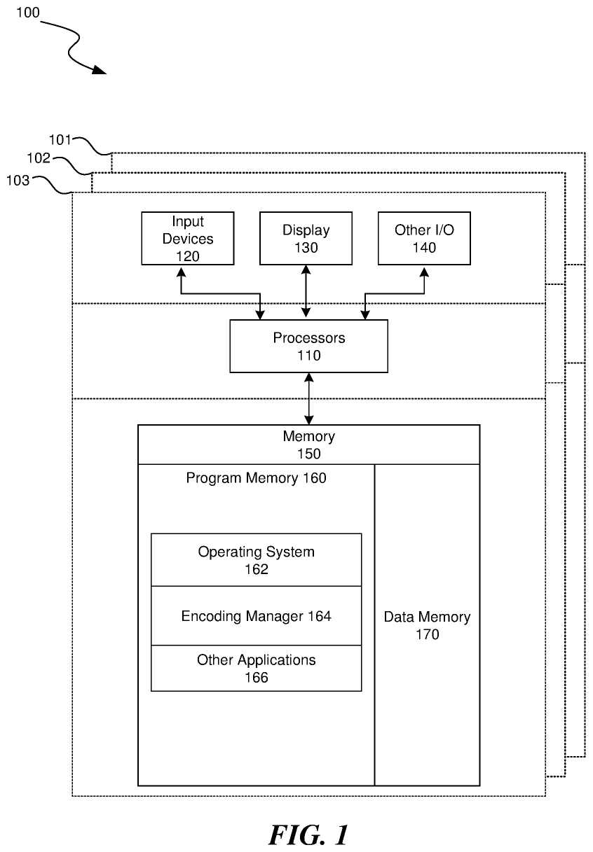

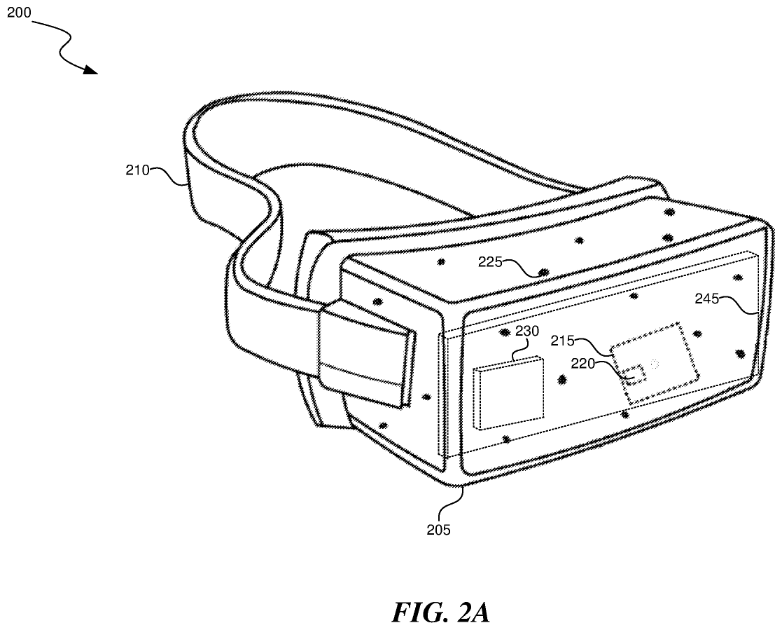

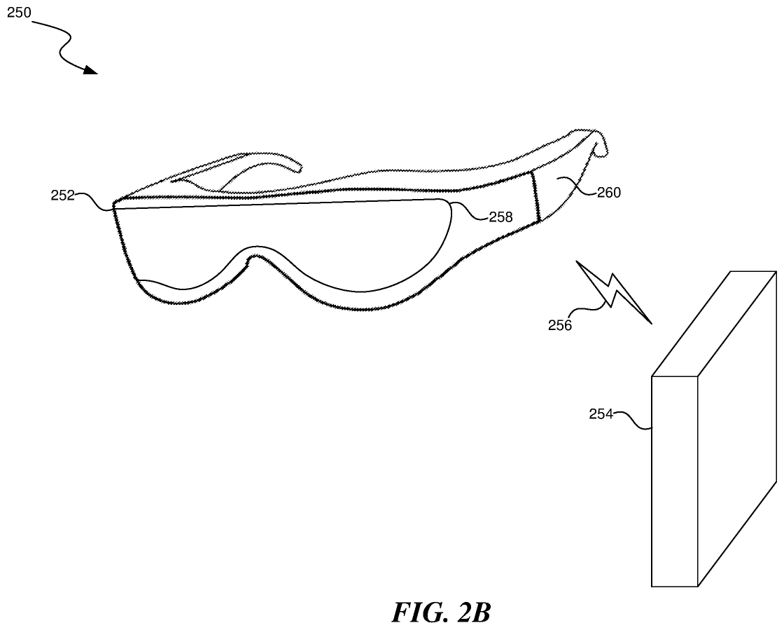

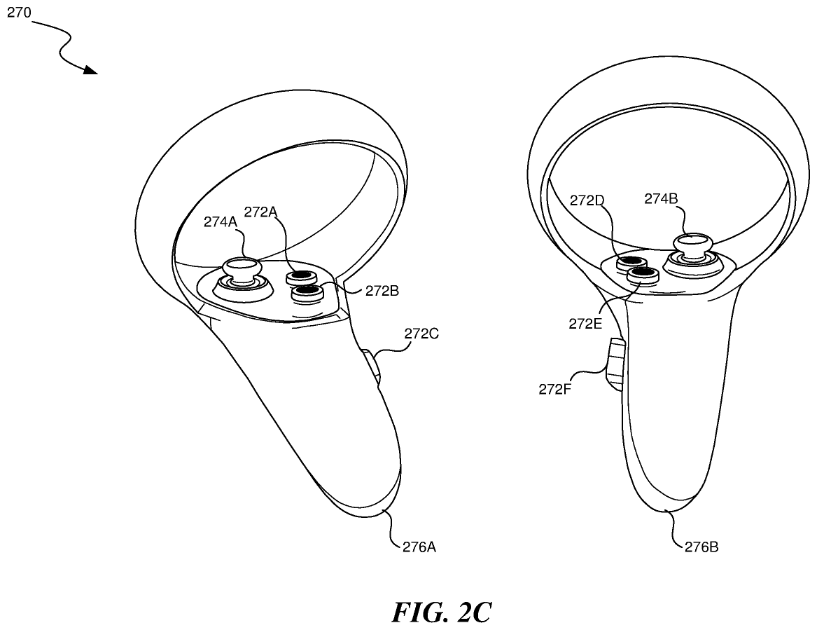

Several implementations are discussed below in more detail in reference to the figures. FIG. 1 is a block diagram illustrating an overview of devices on which some implementations of the disclosed technology can operate. The devices can comprise hardware components of a computing system 100 that apply encoding techniques for discontinuous visual data. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, encoding manager 164, and other application programs 166. Memory 150 can also include data memory 170 that can include, e.g., visual data encodings, an encoding library, sampling data values, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

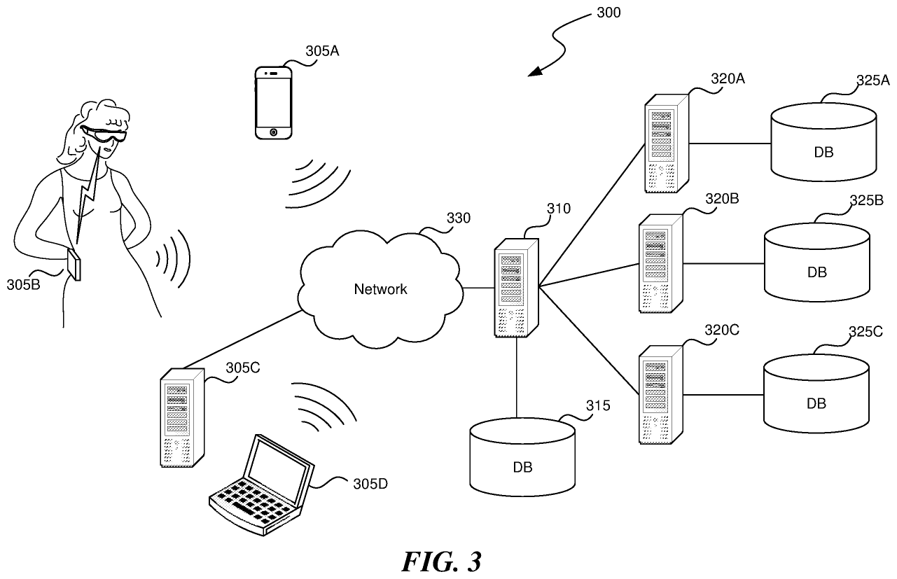

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

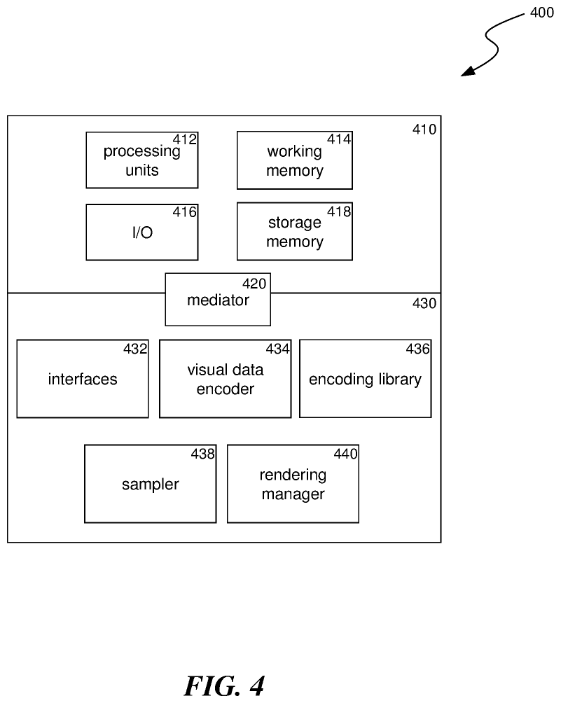

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network. FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for applying encoding techniques for non-linear visual data sampling. Specialized components 430 can include visual data encoder 434, encoding library 436, sampler 438, rendering manager 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Data encoder 434 can generate encodings for visual data comprising discontinuous color value. For example, data encoder 434 can segment visual data such that each segment comprises a single discontinuous portion with respect to two color values. Data encoder 434 can further generate values for each segment that represent a shape of the discontinuous portion. In an example where each segment is a block, the generated values can correspond to the four corners of the block. In some implementations, these corner values can be sampled using bilinear filtering with respect to a particular point within the segment, and the resultant sampled value can represent a color selection metric relative to the point. This color selection metric can be used to generate a color value relative to the point when performing sampling using the generated encoding. In some implementations, for a given segment, the encoding can store: a) the two color values present within the segment; and b) the values that represent the shape of the discontinuous portion.

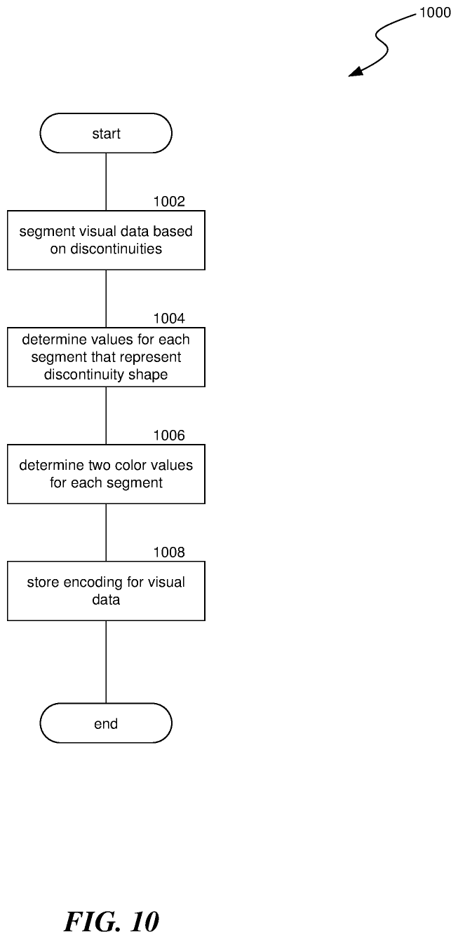

Implementations of data encoder 434 can also generate segments of varying sizes, such as to improve the storage and/or operational efficiency of the encoding. In this example, for a given segment, the encoding can store: a) the two color values present within the segment; b) the plurality of values that represent the shape of the discontinuous portion; c) coordinates for the segment location with respect to the overall visual data; and d) a size of the segment. Further details regarding data encoder 434 are described with respect to blocks 1002, 1004, 1006, and 1008 of FIG. 10.

Encoding library 436 can comprise a set of predefined encodings that correspond to a set of discontinuous portion shapes. For example, each predefined encoding can comprise a segment shape and a plurality of values (e.g., four values that correspond to the four corners of a block) that represent the discontinuous portion shape. Color values (e.g., a min color value and a max color value) can be added to a given predefined encoding so that the predefined encoding can be applied to a given element of visual data (e.g., image, texture, etc.). In some implementations, when data encoder 434 generates an encoding for a new element of visual data, one or more predefined encodings from encoding library 436 can be used to encode the new visual data. Further details regarding encoding library 436 are described with respect to block 1004 of FIG. 10.

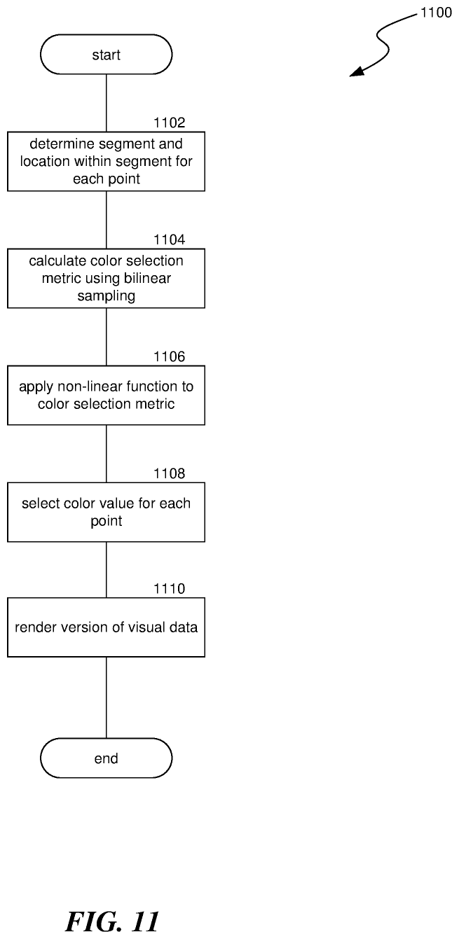

Sampler 438 can perform sampling of visual data and/or encodings for visual data. For example, sampler 438 can perform bilinear filtering, trilinear filtering, or any other suitable sampling related to rendering visual data. Sampler 438 can also implement a specific sampling technique that corresponds to the encoding scheme of data encoder 434, such as an encoding scheme for discontinuous visual data. In some implementations, sampler 438 can be used to upscale or downscale visual data. Further details regarding sampler 438 are described with respect to blocks 1102, 1104, 1106, and 1108 of FIG. 11.

Rendering manager 440 can render visual data, such as visual data represented by the encodings generated via data encoder 434. The visual data can comprise images, textures, or any other suitable visual data. In some implementations, rendering manager 440 can render upscaled or downscaled versions of visual data by: sampling, via sampler 438, points of the visual data using its encoding (e.g., generated by data encoder 434); and rendering the version of visual data using the colors values for the points generated by the sampling. Rendering manager can perform draw calls and/or rendering passes using application programming interface (API) calls to hardware (e.g., one or more central processing units (CPUs), one or more graphics processing units (GPUS), a combination of these, and the like). Further details regarding rendering manager 440 are described with respect to blocks 1110 of FIG. 11.

Implementations encode visual data using an encoding scheme that improves sampling for visual data with stark discontinuities. Discontinuous visual data can include any visual data with a stark color difference, such as blue text on a red background. In this example, the portion of the visual data where the blue of an alphanumeric character is adjacent to the red of the background comprise a stark color difference. In other words, this portion of the visual data comprises a discontinuous portion of the visual data. Conventional sampling techniques, such as those commonly utilized when upscaling or downscaling an element of visual data (e.g., image, texture, etc.), often perform poorly when sampling discontinuous visual data.

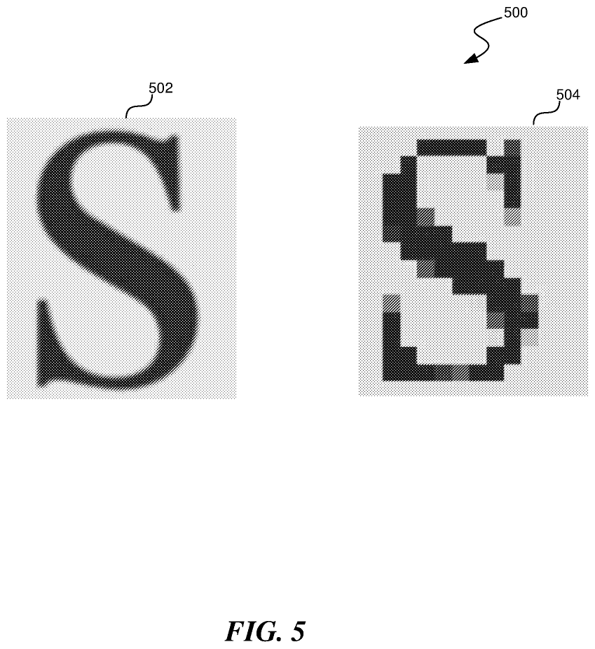

FIG. 5 illustrates conceptual diagrams of a portion of visual data and the portion of visual data after conventional sampling. Diagram 500 includes visual data 502 and sampled version of visual data 504. Visual data 502 can represent the ‘ground truth’ of the visual data, such as the original version of an image stored as a bitmap in its original scale. In an example, visual data 502 can comprise a blue capital letter “S” against a yellow background. Any other suitable color scheme can be implemented.

Sampled version of visual data 504 can represent the visual data after sampling according to a conventional sampling technique, such as linear filtering (e.g., bilinear filter, trilinear filtering, etc.) or any other suitable conventional sampling technique. As depicted, sampled version of visual data 504 has lost the crisp and stark color separation between the letter S and the background, instead blurring this boundary. This quality loss when sampling can occur due to an incompatibility between stark color separations and the technique that conventional sampling applies when calculating color values for a sampled point.

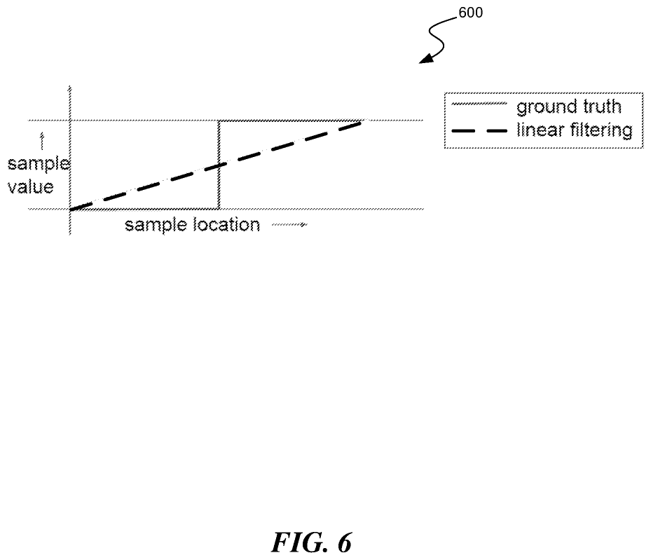

FIG. 6 illustrates a graph that compares ground truth visual data and sampled visual data. Graph 600 depicts sample value on the y-axis (e.g., color value) and sample location (e.g., coordinates with respect to the original visual data) on the x-axis. Graph 600 illustrates how conventional sampling, such as bilinear filtering, fails to uphold color values for diverse sample locations. For example, linear filtering averages color values between two or more locations when sampling a point at a particular location. Graph 600 illustrates the impact of this averaging with respect to discontinuous colors, as the graphed “ground truth” color value depicts a stark color change (e.g., similar to a graphed step function) at a specific sample location while the linear filtered color value depicts a gradual slope between colors values across the sample locations. In practice, this gradual slope corresponds to a color gradient as opposed to a stark color change. The resultant color gradient causes the blurring and loss of color integrity illustrated by sampled version of visual data 504 of FIG. 5.

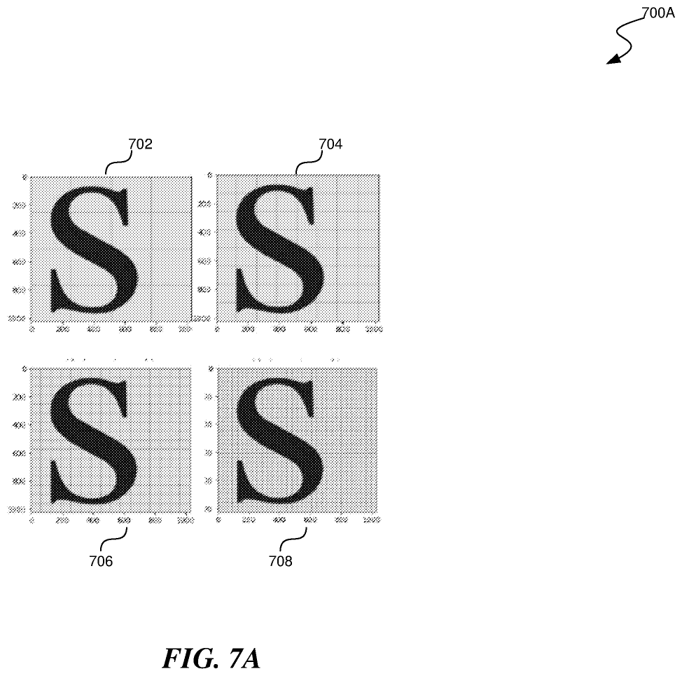

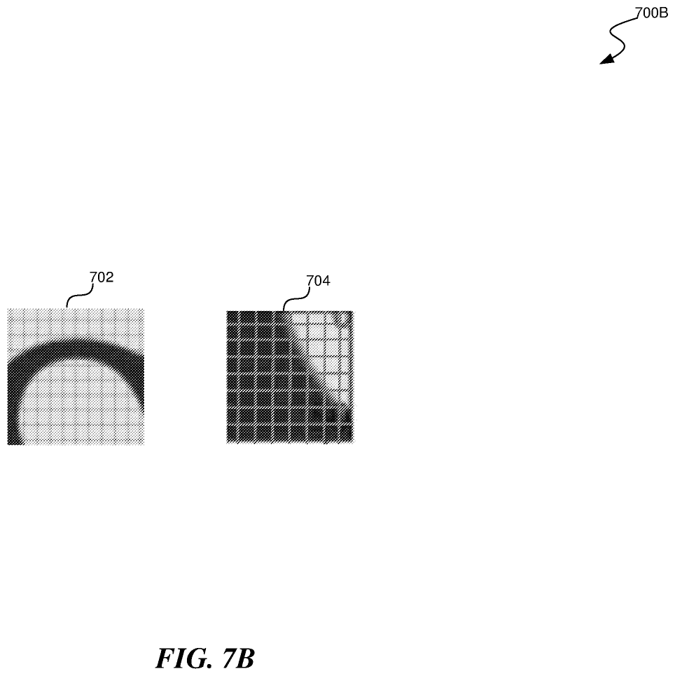

Implementations encode discontinuous visual data using an encoding scheme configured to uphold stark color changes and/or color boundaries when sampled. For example, the encoding scheme can initially segment an element of visual data (e.g., image, texture, etc.) into a plurality of segments that comprise a single discontinuous portion (e.g., color boundary) between two colors. FIGS. 7A and 7B illustrate conceptual diagrams of segmented visual data. Diagram 700A includes segmented visual data 702, 704, 706, and 708.

In some implementations, the encoder can segment the original visual data (e.g., stored as bitmap) until each segment comprises a single boundary (e.g., between two colors) with a shape that can be represented by: a) four corner values of the segment; and b) an encoder specific sampling function. In this example, the four corner values of the segment can be used during sampling to generate a color value with respect to any particular point within the segment.

Within the context of the encoding scheme, a given segment comprises a single discontinuous portion (e.g., color boundary) with respect to two colors (a first color and a second color) when: the number of color changes from the first color to the second color or the second color to the first color in each row of the segment is less than or equal to one; and the number of color changes from the first color to the second color or the second color to the first color in each column of the segment is less than or equal to one. When a given segment meets these conditions, linear filtering combined with a non-linear function can be applied to the four corners values of the segment to distinguish between the two color values present in the segment for any location within the segment.

Diagram 700B includes segment 702 and segment 704. Segment 702 does not meet the above-noted conditions, as both rows and columns of the segment comprise multiple instances of color changes. On the other hand, segment 704 meets these above, and thus comprises a single discontinuous portion. During encoding, implementations of the encoder iteratively segment the visual data until each segment comprises only a single discontinuous portion. For example, the encoder can segment 702 into smaller segments that each comprise a single discontinuous portion.

In some implementations, the encoder maintains a common size for each segment and determines the largest segment size for which all segments of the visual data contain only a single discontinuous portion. For example, the encoder can initialize at a first segment size and inspect each segment to determine whether each segment complies with the above conditions. When the segments do not meet the conditions, the encoder can decrease the segment size and reinspect the new segments. When the segments meet the conditions, the encoder can increase segment size and repeat the inspection until a maximum segment size is determined. Segmented visual data 702, 704, 706, and 708 demonstrates this iterative approach, where each instance of the segmented visual data represents a different segment size and segment grid.

In some implementations, the encoding scheme stores one or more values for each segment that can be used to sample color values at points of the segment. The encoder can calculate the one or more values for each segment (e.g., the corner values) using an iterative calculation and adjustment protocol (e.g., gradient descent), by matching the visual data of a segment to a library of encodings, or by any other suitable technique. For example, within the context of the encoding scheme, the four corner values of a segment are used by an encoding specific sampling technique to discern the color value at any particular point of the segment. Because the segment only includes a single discontinuous portion (e.g., meets the above-noted conditions for a segment of the encoding), the four corner values and the encoding specific sampling technique can practically perform this function.

In some implementations, the encoding specific sampling technique for a given point of a segment includes: performing linear filtering using the four corner values and the coordinates of the given point with respect to the segment; and applying a non-linear function (e.g., ReLu, sigmoid, etc.) to the result of the linear filtering. In this example, the linear filtering uses the four corner values and the relative distance of each corner to the coordinates of the given point to generate a color selection metric. When the four corner values are configured, the non-linear function applied to the color selection metric can accurately indicate the color of the point location within the segment. For example, the result of the applied non-linear function can generate a value between zero and one. When the result value is closer to zero, the distinguished color for the sampled point is a first of the two colors contained in the segment (e.g., a minimum color) and when the result is closer to one the distinguished color for the sampled point is a second of the two colors (e.g., a maximum color). The following is an example mathematical representation of this relationship: clamp(ReLU (linear_sampled_value), 0, 1)=0 or 1; a ‘0’ value indicates the minimum color; a ‘1’ value indicates the maximum color.

In some implementations, when configuring the one or more values of a given segment (e.g., four corner values), the encoder can initialize the values in any suitable manner (e.g., random, weighted according to a neighbor segment, etc.). The encoder can then perform the encoding specific sampling technique for points at different locations of the segment, and compare the results of the sampling to the ground truth for the given segment (e.g., as defined by the stored bitmap of the visual data). Based on the comparison, the encoder can adjust the one or more values (e.g., corner values) until the encoding specific sampling techniques using the one or more values accurately distinguish the colors across the points of a segment. For example, a gradient descent technique can be applied to adjust the one or more values based on the results of the ground truth comparisons.

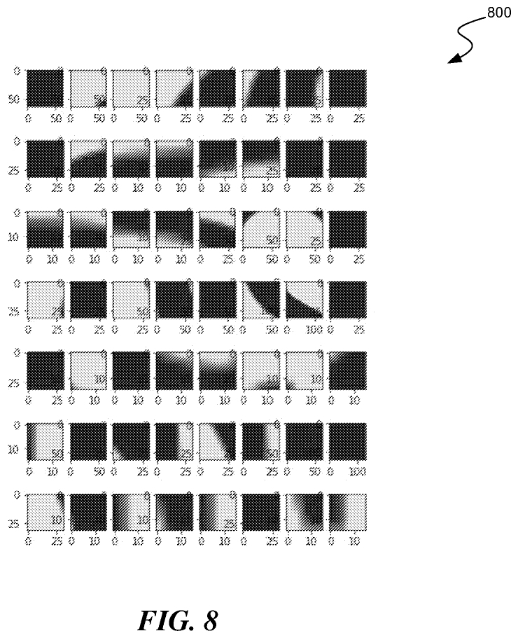

In some implementations, the encoder can match the visual data of a given segment to a library of predefined encoded segments in order to determine the one or more values (e.g., corner values) for the given segment. FIG. 8 illustrates a conceptual library of discontinuous visual data encodings. Library 800 visually depicts examples of predefined segment encodings comprising a variety of discontinuous visual data shapes. Each predefined segment encoding depicted in library 800 can correspond to one or more segment data values (e.g., corner values).

In some implementations, the predefined segment encodings can comprise corresponding predefined bitmap representations. For a given segment, the encoder can compare the segment shape (e.g., segment color boundary according to the bitmap of the visual data) to the bitmap representations of the predefined segment encodings. In this example, each bitmap representation of a predefined segment encoding can comprise two color values. Similarly, the given segment can also comprise two color values. Though the two color values from a bitmap representation may differ from the two color values contained in the given segment, the actual color values themselves are not impactful to the comparison. This is because the matching is based on the shape of the discontinuous portion (e.g., color boundary), not the actual color values. Accordingly, when performing the comparisons, the actual color values can be abstracted so that the shape is effectively compared. For example, in order to perform comparisons between the discontinuous shape (e.g., color boundary) present in predefined bitmap representations and the discontinuous shape present in a given segment, the color values can be replaced with two generic values capable of representing a color boundary.

In some implementations, a given segment can be compared to a plurality of predefined segment encodings, and when the comparison indicates a match that meets a criteria (e.g., 90% match, 95% match, 99% match, etc.) the one or more values (e.g., corner values) of the matching predefined segment encoding can be used to generate the encoding of the given segment. In some implementations, when a partial match is found (e.g., a match that does not meet the criteria) the one or more values (e.g., corner values) of the partially matching predefined segment encoding can be used to initialize the one or more values of the given segment. These initialized values can then be adjusted according to the iterative techniques described herein (e.g., gradient descent) to finalize the one or more values for the given segment.

In some implementations, the encoding data stored for a given segment can include: a minimum color value; a maximum color value; and one or more values that represent the shape of the discontinuous content of the given segment (e.g., color boundary), such as the corner values for a segment comprising a block shape. The encoding for an element of visual data (e.g., image, texture, etc.) can comprise the combined encodings of its segments. In some implementations, the encoding for a segment can include the one or more values that represent the shape of the discontinuous content of the segment, and the minimum and maximum color values of the segment can be stored separately.

The encoding of the visual data can be used to sample points of the visual data, for example for upscaling or downscaling (e.g., altering the rendered/displayed scale) the visual data. Sampling the encoding of the visual data can include performing the encoding specific sampling techniques using coordinates for a plurality of points (e.g., coordinates with respect to the visual data bitmap). For example, for a given point with given coordinates, the encoding specific sampling technique can include: determining the segment for the given point and the point location within the segment; performing linear filtering using the one or more values (e.g., corner values) of the segment encoding and the point location within the segment; applying a non-linear function (e.g., ReLu, sigmoid, etc.) to the output of the linear filtering; and resolving the result of the non-linear function application to select the minimum color value of the segment encoding or the maximum color value of the segment encoding. In some implementations, the encoding specific sampling technique can resolve color values for the visual data so that discontinuous portions of the visual data can be rendered/displayed at different scales with improved fidelity.

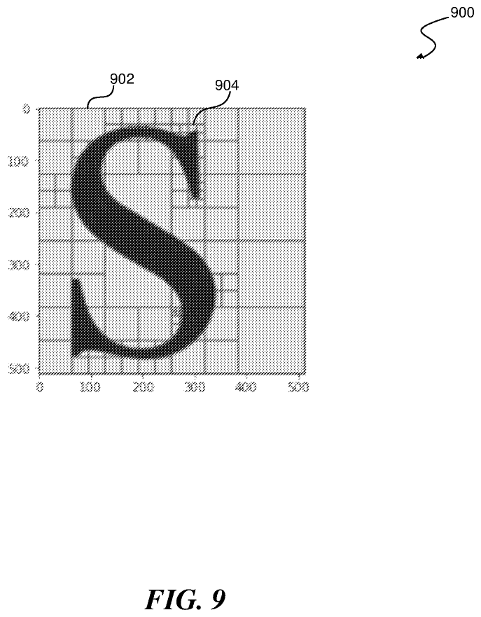

Some implementations of an encoding scheme can utilize variable segment sizes when generating visual data encodings. FIG. 9 illustrates a conceptual diagram of an encoding for discontinuous visual data with variable segment sizes. Visual data 900 is segmented using variable segment sizes. For example, segment 902 comprises a larger size than segment 904. In some implementations, an encoder can generate variable segment sizes by iteratively altering individual segments until the individual segments comprise a single discontinuity. For example, although segment 902 comprises a larger size than segment 904, both segments comprise a single discontinuous portion (e.g., meet the conditions for a segment with a single discontinuous portion), as described with reference to FIGS. 7A and 7B.

In some implementations, the encoder can initialize a default segment size and inspect each segment. When an inspected segment meets the single discontinuous portion conditions, the encoder can maintain the segment's size. When an inspected segment does not meet the single discontinuous portion conditions, the encoder can split the segment (e.g., in half, in fourths, etc.), and inspect the new segments generated by the splitting. The encoder can iteratively inspect segments and, when single discontinuous portion conditions are not met, split the segment(s) until each segment meets the single discontinuous portion conditions. Such a technique can generate segments of different sizes, as illustrated by visual data 900.

In this example, when each segment is confirmed as comprising a single discontinuous portion, the encoder can configure the one or more values (e.g., corner values) for the segments, such as via gradient descent, library matching, or any other suitable technique. Due to the variable segment sizes, the encoding for the segments contains additional segment data. For example, the encoding data stored for a given segment when implementing variable segment sizes can include: a minimum color value; a maximum color value; one or more values that represent the shape of the discontinuous content of the given segment (e.g., color boundary); coordinates of the segment with respect to the visual data (e.g., bitmap representation); and a segment size. In some implementations, the minimum and maximum color values of the segment can be stored separately.

When performing the encoding specific sampling technique using such an encoding scheme, the sampler can use the additional coordinates data and segment size data to determine the particular segment that contains a given point and the point's specific location within the particular segment. Because segments of different sizes present a non-uniform grid, the sampler utilizes the additional coordinates data and segment size data to determine the location of a given point with respect to the segments of the encoding.

Those skilled in the art will appreciate that the components illustrated in FIGS. 1-6, 7A, 7B, 8, and 9 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 10 is a flow diagram illustrating a process used in some implementations of the present technology for generating encodings for discontinuous visual data. Process 1000 can be performed at any system configured to process visual data, such as XR system(s), server(s), client device(s) (e.g., laptops, smartphones, wearable devices, desktops, smart home devices, etc.), or any other suitable computing system comprising a computer processor. Process 1000 can be triggered by any suitable software code that encodes visual data.

At block 1002, process 1000 can segment visual data based on discontinuities contained in the visual data. Example visual data includes images, textures, and the like. The visual data can be stored according to any suitable visual data storage format (e.g., bitmap, etc.). In some implementations, the visual data can comprise discontinuous portions, such as stark color changes (e.g., color boundaries). For example, the visual data can comprise alphanumeric characters of a first color against a background of a second color.

In some implementations, the visual data can be segmented such that each segment contains a single discontinuous portion. For example, a segment can contain a single discontinuous portion when: the number of color changes from a first color to a second color or the second color to the first color in each row of the segment is less than or equal to one; and the number of color changes from the first color to the second color or the second color to the first color in each column of the segment is less than or equal to one.

Implementations can iteratively alter segment size until each segment meets these conditions. For example, the segments can each comprise the same size, and this same segment size can be iteratively adjusted until each segment meets these conditions. In another example, segments can comprise different sizes, and the segment size of each individual segment can be altered until the segments meet these conditions.

At block 1004, process 1000 can determine one or more values for each segment that represent that discontinuous portion of the segment. For example, the one or more values can be configured by iteratively: performing an encoding specific sampling technique using the one or more values across different points of the segment; comparing the sampled color values for the points to ground truth color values defined by the visual data (e.g., bitmap); and altering the one or more values when the sampled color values are inconsistent with the ground truth color values. A gradient descent technique can be used to alter the one or more values based on the comparisons. In some implementations, the one or more values can comprise corner values of a block segment.

At block 1006, process 1000 can determine two color values for each segment. For example, the color values for a segment can be comprise a minimum color value and a maximum color value contained in the segment. At block 1008, process 1000 can store the encoding generated for the visual data. In some implementations, the encoding data stored for a given segment can include: a minimum color value; a maximum color value; and one or more values that represent the shape of the discontinuous content of the given segment (e.g., color boundary), such as the corner values for a segment comprising a block shape. In some implementations, the encoding data stored for a given segment when implementing variable segment sizes can include: a minimum color value; a maximum color value; one or more values that represent the shape of the discontinuous content of the given segment (e.g., color boundary); coordinates of the segment with respect to the visual data (e.g., bitmap representation); and a segment size. The minimum and maximum color values of a segment can be stored separately from the segment's encoding.

FIG. 11 is a flow diagram illustrating a process used in some implementations of the present technology for sampling discontinuous visual data encodings. Process 1100 can be performed at any system configured to render visual data, such as XR system(s), server(s), client device(s) (e.g., laptops, smartphones, wearable devices, desktops, smart home devices, etc.), or any other suitable computing system comprising a computer processor. Process 1100 can be triggered by any suitable software code that samples or renders visual data.

At block 1102, process 1100 can determine, for each point sampled from the encoded visual data, a segment for the point and a location within the segment for the point. For example, the coordinates of each point can be used to determine the segment in which the point is located and the relative location of the point within the segment.

At block 1104, process 1100 can calculate, for each point sampled from the encoded visual data, a color selection metric using the determined segment and determined location within the segment. For example, the one or more values (e.g., corner values) of the determined segment and the relative location of the point within the determined segment can be used to perform linear filtering. The value generated from the linear filtering for each point can comprise the color selection metric of the point.

At block 1106, process 1100 can apply, for each point sampled from the encoded visual data, a non-linear function to the color selection metric. For example, the non-linear function can comprise a ReLu function, sigmoid function, or any other suitable non-linear function. At block 1108, process 1100 can select, for each point sampled from the encoded visual data, a color value. For example, the output from the non-linear function can comprise a number between zero and one. To perform the sampling, a segment is determined for each point location with respect to the visual data (e.g., bitmap). The encoding (or another suitable data structure) can store two color values affiliated with each segment, such as a maximum color value and a minimum color value. In some implementations, the minimum color value of a segment determined for a given point can be selected when the output from the non-linear function is closer to zero, and the maximum color value of a segment for a given point can be selected when the when the output from the non-linear function is closer to one.

At block 1110, process 1100 can render a version of the visual data using the sampled points and color values. For example, one or more processors can render a version of the visual data using the sampled points. The one or more processors can comprise GPUs and/or CPUs that render the version of the visual data using the sampled points during a rendering pass. In some implementations, the rendered version of visual data comprises an upsampled version of the visual data or a downsampled version of the visual data.

The upsampled version and/or downsampled version can correspond to a scaled version of the visual data, and the color values of the sampled points can implement display/rendering of the scaled version with improved quality. For example, the visual data can comprise a stark color boundary, and the color values of the sampled points can be used to scale the visual data and maintain the quality of the stark color boundary. In some implementations, the stark color boundary corresponds to displayed/rendered text.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for applying encoding techniques for non-linear visual data sampling, the method comprising:
storing an encoding for visual data, the encoding comprising a plurality of segments, wherein:
each segment comprises a single discontinuous portion with respect to two color values, and
for each segment, the encoding stores a plurality of values that represent a shape of the segment's discontinuous portion; and
sampling points of the visual data using the encoding, wherein each point is sampled by:
determining a segment for each point and a location within the determined segment for each point,
calculating a color selection metric using: a) the determined location within the determined segment, and b) the plurality of values of the determined segment, and
selecting a color value from the determined segment's two color values by applying a selection function to the calculated color selection metric;
wherein one or more processors render a version of the visual data using the sampled points.

2. The method of claim 1, wherein each segment comprises a block with four corners, and the plurality of values that represent the shape of a segment's discontinuous portion comprise four values that correspond to the four corners.

3. The method of claim 2, wherein calculating the color selection metric further comprises:
performing linear filtering using: a) the four values of the determined segment; and b) the determined location within the determined segment, wherein the linear filtering generates the color selection metric.

4. The method of claim 3, wherein:
the selection function comprises a non-linear function,
applying the non-linear function to the calculated color selection metric generates a binary value, and
the generated binary value maps to one of the determined segment's two color values.

5. The method of claim 4, wherein the non-linear function comprises a ReLu function or a sigmoid function.

6. The method of claim 1, wherein the plurality of segments comprise multiple sizes, and the encoding stores a segment size and segment location for each segment.

7. The method of claim 1, wherein the visual data comprises an image or texture.

8. The method of claim 7, wherein the visual data comprises alphanumeric characters.

9. The method of claim 1, wherein the one or more processors comprise graphical processing units (GPUs) that render the version of the visual data using the sampled points during a rendering pass.

10. The method of claim 9, wherein the rendered version of visual data comprises an upsampled version of the visual data or a downsampled version of the visual data.

11. The method of claim 1, wherein the plurality of values that represent the shape of a segment's discontinuous portion are generated using gradient descent.

12. The method of claim 1, wherein the plurality of values that represent the shape of a segment's discontinuous portion are generated using a library of predefined encoded segments.

13. The method of claim 1, further comprising:
generating the encoding for the visual data by, for one or more segments, iteratively refining the plurality of values that represent the shape of a segment's discontinuous portion using grading descent.

14. The method of claim 1, further comprising generating the encoding for the visual data by:
matching color values of one or more segments to color values of predefined encoded segments; and
generating, for the one or more segments, the plurality of values that represent the shape of a segment's discontinuous portion using values stored for the matching predefined encoded segments.

15. A computer-readable storage medium storing instructions that, when executed by a computing system, cause the computing system to perform a process for applying encoding techniques for non-linear visual data sampling, the process comprising:
storing an encoding for visual data, the encoding comprising a plurality of segments, wherein:
each segment comprises up to a single discontinuous portion with respect to two color values, and
for each segment the encoding stores one or more values that represent a shape of the segment's discontinuous portion; and
sampling points of the visual data using the encoding, wherein each point is sampled by:
determining a segment for each point and a location within the determined segment for each point,
calculating a color selection metric using: a) the determined location within the determined segment, and b) the one or more values of the determined segment, and
selecting a color value from the two color values by applying a selection function to the calculated color selection metric;
wherein one or more processors render a version of the visual data using the sampled points.

16. The computer-readable storage medium of claim 15, wherein the two colors values comprise: two color values affiliated with the segment determined for each sampled point; or two color values affiliated with the visual data.

17. The computer-readable storage medium of claim 15, each segment comprises a block with four corners, and the one or more values that represent the shape of a segment's discontinuous portion comprise four values that correspond to the four corners.

18. The computer-readable storage medium of claim 17, wherein calculating the color selection metric further comprises:
performing linear filtering using: a) the four values of the determined segment; and b) the determined location within the determined segment, wherein the linear filtering generates the color selection metric.

19. The computer-readable storage medium of claim 18, wherein:
the selection function comprises a non-linear function,
applying the non-linear function to the calculated color selection metric generates a binary value, and
the generated binary value maps to one of the determined segment's two color values.

20. A computing system for applying encoding techniques for non-linear visual data sampling, the computing system comprising:
one or more processors; and
one or more memories storing instructions that, when executed by the one or more processors, cause the computing system to perform a process comprising:
storing an encoding for visual data, the encoding comprising a plurality of segments, wherein:
each segment comprises up to a single discontinuous portion with respect to two color values, and
for each segment the encoding stores one or more values that represent a shape of the segment's discontinuous portion; and
sampling points of the visual data using the encoding, wherein each point is sampled by:
determining a segment for each point and a location within the determined segment for each point,
calculating a color selection metric using: a) the determined location within the determined segment, and b) the one or more values of the determined segment, and
selecting a color value from the two color values by applying a selection function to the calculated color selection metric;
wherein one or more processors render a version of the visual data using the sampled points.
